(19) United States
(12) Patent Application Publication
(10) Pub. No.: US 2014/0158656 A1
(43) Pub. Date: Jun. 12, 2014

(54) COMBINATION MOBILE BOOM TRUCK & TOWER CRANE

(71) Applicant: Charles Pembleton, Hamilton (CA)

(72) Inventor: Charles Pembleton, Hamilton (CA)

(21) Appl. No.: 14/077,307

(22) Filed: Nov. 12, 2013

Related U.S. Application Data
(60) Provisional application No. 61/733,944, filed on Dec. 6, 2012.

(51) Int. Cl. B66C 23/36; B66C 23/16; B66C 23/00

(52) U.S. Cl. CPC B66C 23/36; B66C 23/54; B66C 23/16
USPC 212/296; 212/295; 212/297

(57) ABSTRACT

The present concept is a combination mobile boom truck and tower crane which includes a boom portion which includes a boom mounted to a truck portion, the boom portion is moveable between a collapsed position and a boom truck position by extending a boom ram, thereby making the combination crane usable as a boom truck. The combination crane additionally includes a tower portion mounted to the truck portion which is moveable between a collapsed position and a tower crane position. In the collapsed position, the boom portion and tower portion are mounted to the truck portion for transport to and from a jobsite.

This application claims priority from previously filed U.S. provisional patent application No. 61/733,944 filed Dec. 6, 2012 by Charles Pembleton under the title COMBINATION MOBILE BOOM TRUCK & TOWER CRANE.

### FIELD OF THE INVENTION

The present concept relates to cranes in general and more particularly relates to mobile boom trucks and tower cranes and more particularly relates to a combination mobile boom truck and tower crane.

### BACKGROUND OF THE INVENTION

Known mobile cranes are generally of the type having a mobile platform for example the chassis of a carrier vehicle and are either a dedicated boom truck which includes a pivoting boom and/or jib having telescoping sections which are mounted onto a mobile carrier such as a flatbed truck.

There are also known mobile tower cranes which are described more particularly in patents filed by Donald E. Wellman in U.S. Pat. Nos. 3,934,729, 3,938,670 and 3,939,988 all under the title Tower Crane by Donald E. Wellman. These tower cranes are mounted onto a chassis of a carrier vehicle and are erected for use as a traditional tower crane.

Lifting requirements particularly in urban environments in some instances requires the use of a boom truck for lifting and in other instances requires the use of a tower crane for accomplishing the lifting due to the close proximity of buildings and the ability to position the crane in only certain locations.

There is a need for a combination mobile boom truck and a tower crane which can easily operate as both a traditional boom truck and/or if necessary can be easily erected into the configuration of a tower crane and operated as a tower crane.

The advantages of the herein described combination mobile boom truck and tower crane will become known to the reader as it is described below.

### BRIEF DESCRIPTION OF THE DRAWINGS

The present concept will now be described by way of example only with reference to the following drawings in which:

FIG. 1 is a schematic side elevational view of the combination mobile boom truck and tower crane shown in a collapsed position.

FIG. 2 is a schematic side elevational view of the combination mobile boom truck and tower crane shown in the boom truck operating position.

FIG. 3 is a schematic side elevational view of the combination mobile boom truck and tower crane shown in a partially erected position.

FIG. 4 is a schematic side elevational view of the combination mobile boom truck and tower crane in the erected tower crane position.

### DETAILED DESCRIPTION OF THE PREFERRED EMBODIMENTS

The present invention a combination mobile boom truck and tower crane is shown generally as mobile crane 100 which includes the following major components namely a truck portion 194 including a truck 102, boom portion 190 including boom 104, and a tower portion 192 including a tower 106. Truck portion 194 may be any type of mobile platform for use with mobile cranes including but limited to the truck configuration shown in the figures. It may include a tractor section 183 for motorizing the truck portion 194 thereby providing motive power for transporting the combination crane 100 to and from job sites.

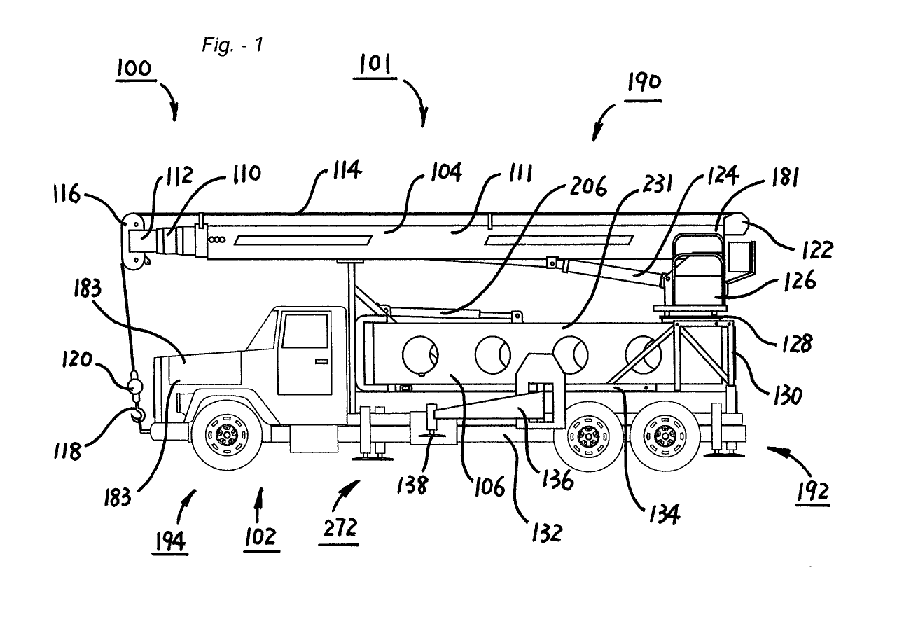

Mobile crane 100 is shown in a collapsed position 101 in FIG. 1 which is the position in which the combination mobile boom truck and tower crane would be moved from one location to the other down roadways.

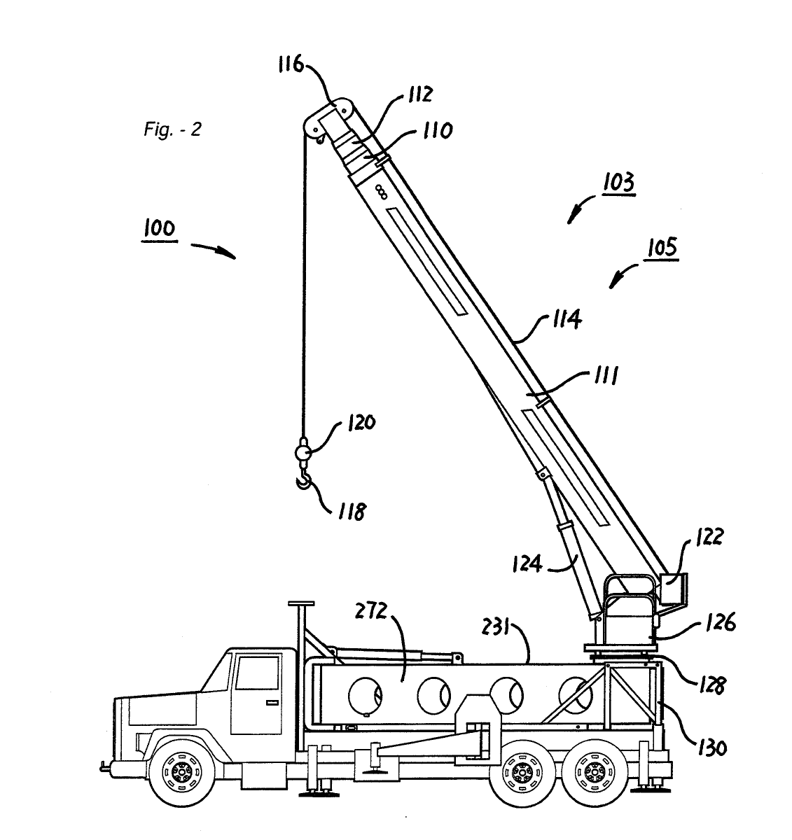

The combination mobile boom truck and tower crane which is depicted as combination crane 100 in both FIGS. 1 & 2 can be used as a traditional boom truck and is shown in a boom truck position 103 in FIG. 2 for example.

The major components in order to operate the combination mobile boom truck and tower crane as a boom truck are the boom portion 190 which includes boom 104 main section 111, which can be extended with telescoping section 110 and telescoping section 112. A winch 122 controls the cable 114 which moves across pulleys 116 and terminates at a hook 118 and includes a ballast 120.

Boom 104 further includes lower end 181 a boom ram 124 which is used to move boom portion 190 into the boom truck position 103 and also select the angle of the boom 104 relative to horizontal. The tower 106 is mounted horizontally in the collapsed position 101 for transporting between job sites. The cab 126 is mounted on an upper side 231 of tower 106 in the collapsed position and is also supported by support frame 130 when the combination crane 100 is in the collapsed position 101 and boom truck position 103.

The operator of boom truck 105 as shown in FIG. 2 for example would enter cab 126 in order to control boom 104 and operate boom truck 105 in the boom truck position 103.

Cab 126 is supported by a cab base 128 which is further supported by support frame 130.

Tower 106 which is shown in a horizontal position laying down flat upon platform 134 of truck frame 132 ready for deployment.

Truck 102 further includes stabilizing outriggers 136 having outrigger pads 138 as well as stabilizing feet 208 located at strategic positions around truck 102.

### In Use—Boom Truck

Combination crane 100 as operated as a boom truck 105 shown in the boom truck position 103 in FIG. 2 requires little setup. The operator simply climbs into cab 126 to control boom ram 124 and is able to raise and lower the main section 111 of boom 104 and also pivot boom 104 around the base 128 of cab 126 thereby being able to position the hook 118 into the desired location. The operator can also deploy outriggers 136 and stabilization feet 208 as required.

The operator can extend boom 104 by raising out telescoping sections 110 and 112 as required and can lift and lower a load by either winching in the cable 114 with winch 122 and/or by raising and lowering boom 104 with boom ram 124.

The reader will note that a minimal amount of set-up time is required in order to put into operation combination crane 100 as a boom truck 105 and to be able to put it into boom truck position 103.

### Tower Crane

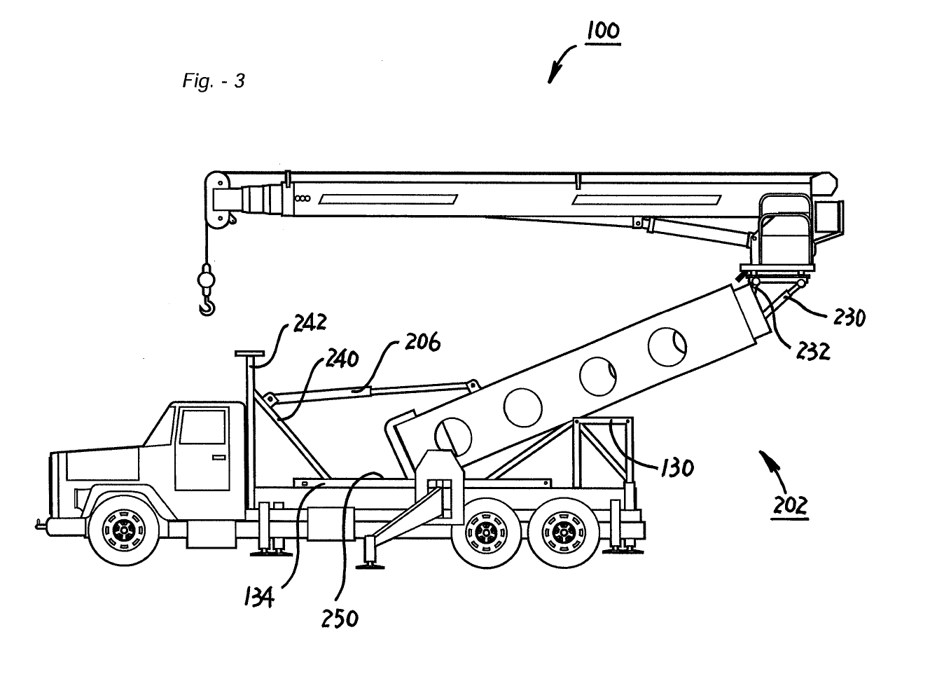

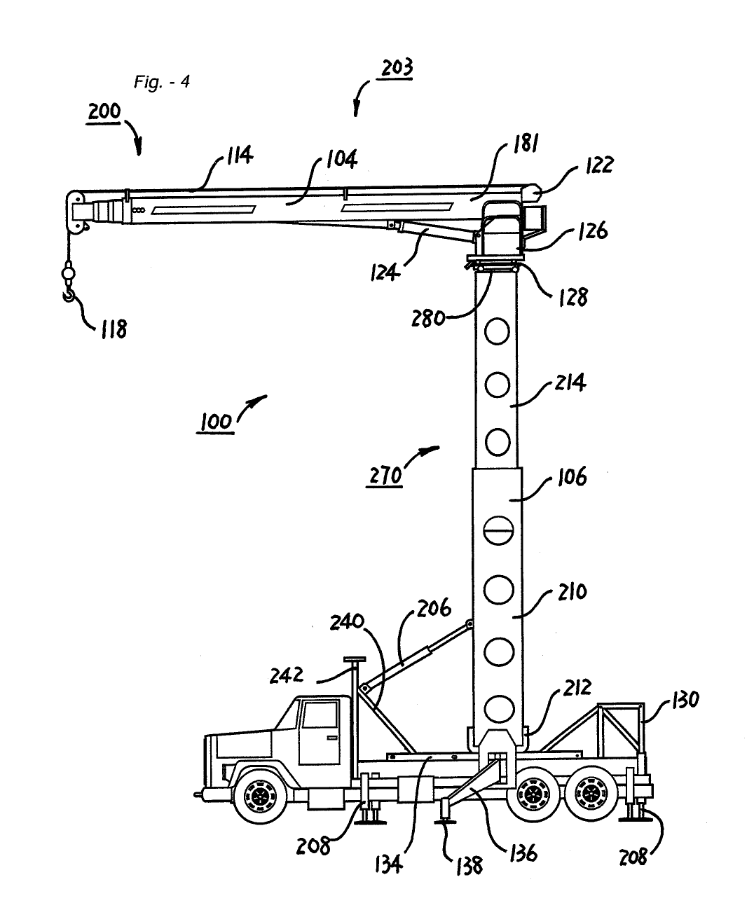

In order to operate the combination mobile boom truck and tower crane as a tower crane 203 the tower portion 192 must be erected from the collapsed position 101 shown in FIG. 1 to the tower crane position 200 shown in FIG. 4. In order to accomplish this a combination of hydraulic cylinder 206 and a tower ram 250 which is hidden from view in the drawings is used to slideably move tower 106 into the partially erected position 202 as shown in FIG. 3. Tower 106 partially rests on support frame 130 as the tower 106 is being raised from the horizontal position to the vertical position.

Cab is approximately always positioned at the lower end 181 of boom 104. Cab 126 pivots from resting on top of upper side 231 of tower 106 such that cab base 128 comes to rest on the top portion 280 of the upper portion 214 of tower 106 when tower 106 is in the vertical position 270. Cab 126 is moved into position using cab cylinder 230 and cab cylinder 232. Hydraulic cylinder 206 is supported by a back stay 242 as well as a cross member 240 which is connected to platform 134.

Hydraulic cylinder 206 as well as tower ram 250 and support frame 130 all work together in order to move and support tower 106 from the horizontal position 272 as shown in FIG. 1 to the tower crane position 200 shown in FIG. 4 in which the tower is standing vertically upright.

Tower 106 includes a lower portion 210 terminating at a tower base 212 and a telescoping upper portion 214 terminating at top portion 280.

The drawings depict a two section tower 106 when in fact tower 106 may have two, three or more sections depending upon the vertical elevation that is required.

The reader will note that cab 126 is now located on the top of portion 280 of tower 106. This enables the operator to have an excellent view downwardly when operating combination crane 100 as a tower crane 203.

### In Use—Tower Crane

When operating combination crane 100 as a tower crane 203 the reader will note that the tower is easily and quickly erected from a horizontal position 272 shown in FIG. 1 to a vertical position 270 shown in FIG. 4. One or more tower portions can be telescopically raised and as depicted in the diagrams in this case a lower portion 210 and an upper portion 214 are used in order to raise tower 106. On the top of the upper portion 214 namely top portion 280 cab 126 is mounted upon cab base 128.

The operator from cab 126 on top of tower 106 can operate the boom by raising and lowering the boom using ram 124 and/or can pivotly rotate the boom 104 about cab base 128. Additionally the operator can extend boom 104 using telescoping sections 110 and 112 and can pay out cable 114 using winch 122 therefore positioning hook 118 in the desired location.

The reader will note that the advantage of combination crane 100 is that first of all the operator is sitting on the top of the tower 106 when the crane is in the tower crane position 200. This provides the operator with an excellent view downwardly such that he can accurately position the hook 118 onto the load that is being lifted.

The major advantages of the present concept namely combination crane 100 is that it can be easily moved into position at a job site and can be operated either as a boom truck wherein almost no setup time is required other than the deployment of the boom and perhaps outriggers 136. In the event it is not possible to carry out the lift using a simple boom truck 105 in the boom truck position 103 due to being “boom bound” meaning it is not possible to reach the desired location with the load using a simple boom then it is possible to erect the tower 106 from the horizontal position 272 into the tower crane position 200 and operate the combination crane 100 as a tower crane 203 shown in FIG. 4 thereby being able to place the combination crane in a position much closer to a building for example thereby avoiding being boom bound.

It should be apparent to persons skilled in the arts that various modifications and adaptation of this structure described above are possible without departure from the spirit of the invention the scope of which defined in the appended claim.

I claim:

1. A combination mobile boom truck and tower crane comprising;
a) a boom portion includes a boom mounted to a truck portion, the boom portion moveable between a collapsed position and a boom truck position by extending a boom ram, thereby making the combination crane usable as a boom truck;
b) a tower portion mounted to the truck portion moveable between a collapsed position and a tower crane position;
c) wherein in the collapsed position the boom portion and tower portion are mounted to the truck portion for transport to and from a jobsite.

2. The combination crane claimed in claim 1 wherein the tower portion includes a tower which is mounted horizontally in a horizontal position to the truck portion in the collapsed position.

3. The combination crane claimed in claim 2 wherein the cab rests on an upper side of the tower when the tower is in the horizontal position.

4. The combination crane claimed in claim 1 wherein the tower moves between a horizontal position when the combination crane is in the collapsed position and a vertical position when the combination crane is in the tower crane position.

5. The combination crane claimed in claim 1 wherein the cab rests on a top portion of the tower when the tower is in the tower crane position.

6. The combination crane claimed in claim 1 wherein the tower is moved from the collapsed position to the tower crane position using an hydraulic cylinder and a tower ram.

7. The combination crane claimed in claim 6 wherein the tower including a tower base which slideably engages along a platform for moving the tower base between a horizontal position and a vertical position.

8. The combination crane claimed in claim 1 wherein the cab is located approximately at a lower end the boom when the combination crane is in the boom truck position and in the tower crane position.

9. The combination crane claimed in claim 1 further including a support frame for supporting the cab when the combination crane is in the collapsed and in the boom truck position.

10. The combination crane claimed in claim 1 further including a support frame for supporting the tower when in a partially erected position.

11. The combination crane claimed in claim 1 wherein the tower including an upper portion telescopically received within a lower portion.

12. The combination crane claimed in claim 11 wherein cab cylinders are housed within the upper portion of the tower, the cylinders for positioning the cab on a top portion of the upper portion of the tower.

13. The combination crane claimed in claim 1 wherein the boom including at least one telescoping section.

14. The combination crane claimed in claim 1 wherein the boom portion includes a winch and cable terminating at a hook for attachment to a load.

15. The combination crane claimed in claim 1 wherein the truck portion includes a flat bed truck having a truck frame.

16. The combination crane claimed in claim 1 wherein the truck portion includes a tractor section for motorizing the truck portion.
